(19) United States
(12) Patent Application Publication
(10) Pub. No.: US 2006/0151454 A1
(43) Pub. Date: Jul. 13, 2006

(54) Apparatus and method for affixing heat treating pads and insulation to a vessel to be girth welded

(75) Inventors: Donato L. Ricci, Hager City, WI (US); Brent Place, Hager City, WI (US); Martin A. Gardzinski, Red Wing, MN (US)

Correspondence Address: NIKOLAI & MERSEREAU, P.A., 900 SECOND AVENUE SOUTH, SUITE 820, MINNEAPOLIS, MN, 55402, US

(73) Assignee: Donato L. Ricci, Hager City, WI (US)

(21) Appl. No.: 11/033,232

(22) Filed: Jan. 11, 2005

(51) Int. Cl. H05B 3/06; H05B 11/00; H05B 3/58

(52) U.S. Cl. 219/201; 219/526; 219/535

(57) ABSTRACT

A girth weld pre-heating system and method is disclosed for pre-heating shell sections of assembled large steel vessels in the vicinity of a girth joint weld seam location between the sections prior to the joining of the sections together by a continuous girth weld. The pre-heating system avoids the need for direct attachment to the steel surfaces of the vessel shell sections in affixing heater elements and insulation to both the outer and inner surfaces of the shell sections along both sides of the weld seam.

### BACKGROUND OF THE INVENTION

I. Field of the Invention

The present invention relates to welding together sections of relatively large metallic vessels such as halves of steam generators in nuclear power plants and, more particularly, to a system and method for affixing heating pad elements and insulation to inner and outer surfaces of assembled sections of such a vessel to apply and maintain a pre-heat along a common weld seam as part of a girth welding operation for joining the sections. The technique of the invention does not require direct fastening or attachment of any elements of the system to the surface of the vessel sections.

II. Related Art

Certain large steel vessels such as steam generator enclosures in nuclear power plants are assembled from a plurality of separate shell sections that are joined by welds. Periodically, these vessels must be opened for inspection and repair of internal workings. This requires cutting about the girth of the vessel to remove the top and open the vessel. Thereafter, the top section must be reassembled to the bottom and the girth rewelded. Owing to the size of the vessels, in order for the welding process to proceed successfully to rejoin the shell sections and reseal the vessel, (and avoid undue stresses in the weld joint) the vicinity of each of the shell sections along the weld seam needs to be pre-heated. To accomplish this, traditionally, an array of ceramic heating pad elements and covering insulation have been affixed to the inner and outer surfaces of the shell sections. This has been done by first tack welding mounting rods or pins to the surfaces of the shell sections and attaching and supporting the heating pad elements and insulation using the mounting pins. Over time, however, scaling and other factors reduce the wall thickness of the shell sections and make the shell sections unsuited for the attachment of mounting rods or pins in this manner. More importantly, the surfaces of the vessel may become pitted in the areas where the pins or support elements are tacked to the vessel wall surfaces. The pitted areas may, in turn, reduce the wall thickness of the vessel to a value under the minimum allowable thickness at these points, necessitating major repairs.

In view of the above, there has developed a definite need for an apparatus and method for affixing heating pad elements and insulation about the periphery of steel vessel shell sections in a manner which does not require direct attachment of rods or pins to the surfaces of the shell sections.

### SUMMARY OF THE INVENTION

By means of the present invention, there is provided a pre-heating and insulating apparatus and method including a support system for temporarily affixing heating pads and insulation about the periphery of the inner and outer surfaces of shell sections of large steel vessels to be joined by a girth weld or seam weld in which the affixing process does not require direct attachment of parts to the surfaces of the shell sections and which achieves proper pre-heating in the vicinity of the weld seam.

The detailed embodiment, which illustrates an example of the invention, includes a system for providing pre-heating for a girth weld seam for a pair of rather large vessel shell sections assembled to form a large vessel and which define a weld seam therebetween to be joined by a girth weld. The insulated pre-heating system involves both inner and outer surfaces of the steel shell of the vessel. A plurality of heating elements are arranged about the entire periphery of the shell sections on either side of the weld seam adjacent the outer surface of the vessel sections. These are covered by a layer of external insulating material overlaying the heating elements. Peripheral strap devices are utilized to hold the heating elements and the insulating material against the outer surface of the vessel shell sections which include upper and lower sections. An outer peripheral strap device made up of clamped together elements is utilized outside the insulating material to hold the insulating material and the heating elements against the outer surface of the lower vessel shell and a pair of straps are utilized to hold the heating elements against the surface of the shell above the weld seam. In the case of the upper portion of the vessel shell, the layer of insulating material is attached to the heating elements which, in turn, are held against the outer surface of the upper portion of the vessel shell by a pair of straps and suspending wires.

Inside the vessel, a layer of insulating material is assembled against a portion of the peripheral inner surface of the upper and lower vessel shells covering the weld seam. This insulation is held against the inner surface of the assembled vessel by a bracing system which includes a central ring and upper and lower adjustable angle braces which cooperate with shaped plate members to brace each of a plurality of insulating material sections against the inner wall of the vessel.

### BRIEF DESCRIPTION OF THE DRAWINGS

In the drawings, where like numerals are utilized to designate like parts throughout the same:

FIG. 1a is a perspective view of assembled sections of a steam generator enclosure vessel showing heating pads and insulation applied to the inner and outer surfaces in preparation for a girth welding operation in accordance with the invention;

FIG. 1b is a view of a portion of an upper retaining band of a lower outer retaining assembly of FIG. 1a;

FIG. 1c is a slightly enlarged view of a fragment of the lower heating pad/insulation assembly of FIG. 1a showing additional details;

FIG. 2a is a side elevational view of the vessel of FIG. 1a;

FIG. 2b is an enlarged view of the fragment 2b designated in FIG. 2a;

FIG. 3 is a perspective detailed view of a portion of the steam generator enclosure showing the outer heating pads and insulation partially assembled;

FIG. 4 is a detailed view of a fragment of the upper section of FIG. 3; and

FIG. 5 is a detailed view of a heating pad/insulation assembly.

### DETAILED DESCRIPTION

The detailed description describes one preferred embodiment of the invention associated with the welding of the girth seam of a steam generator vessel for a nuclear power plant. This embodiment is meant as an example to illustrate the inventive concept rather than to limit the scope of the invention as other applications and variations will occur to those skilled in the art.

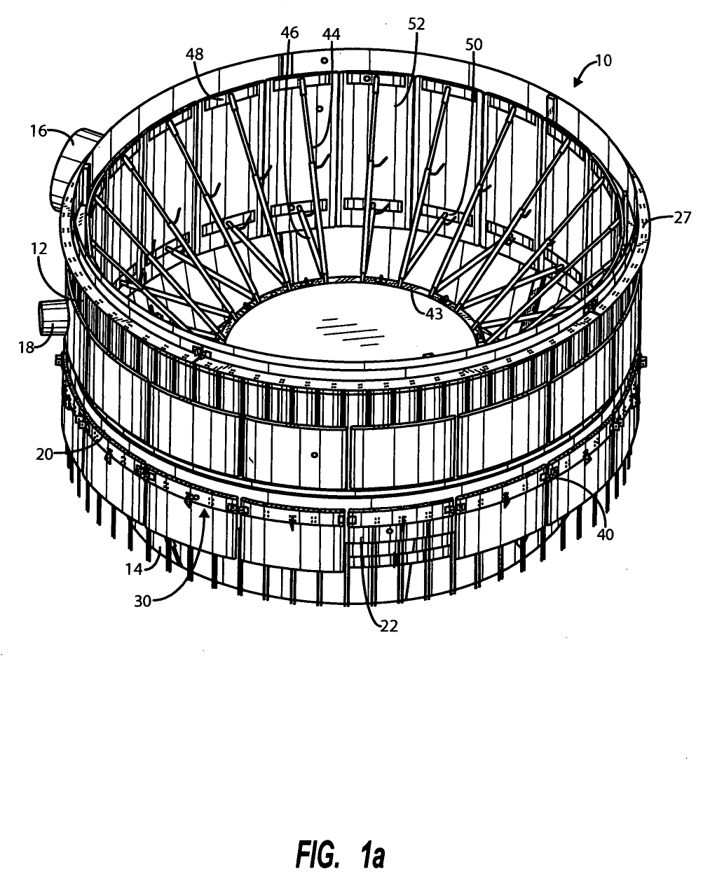

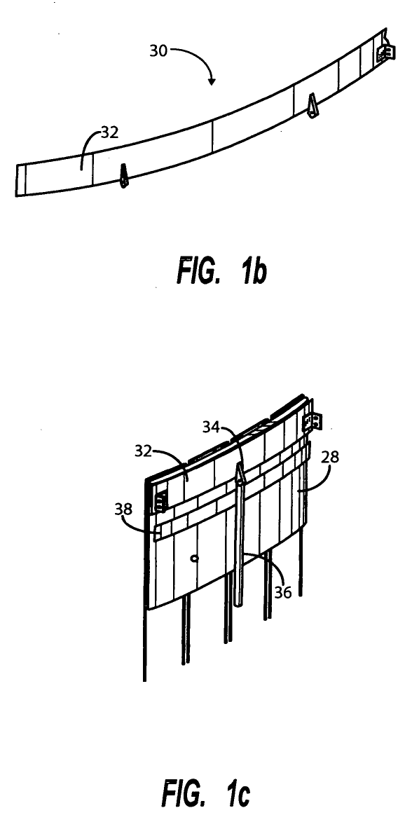

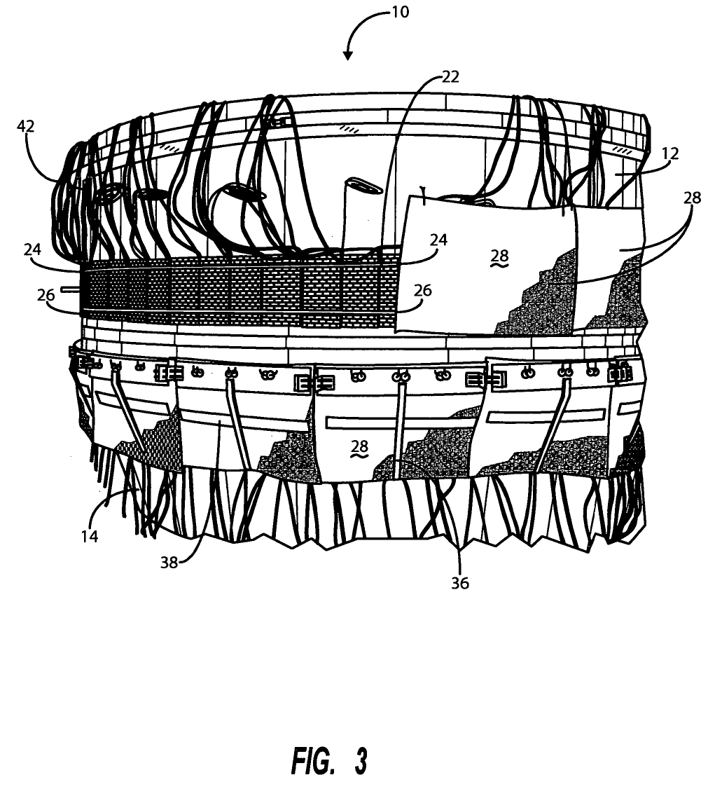

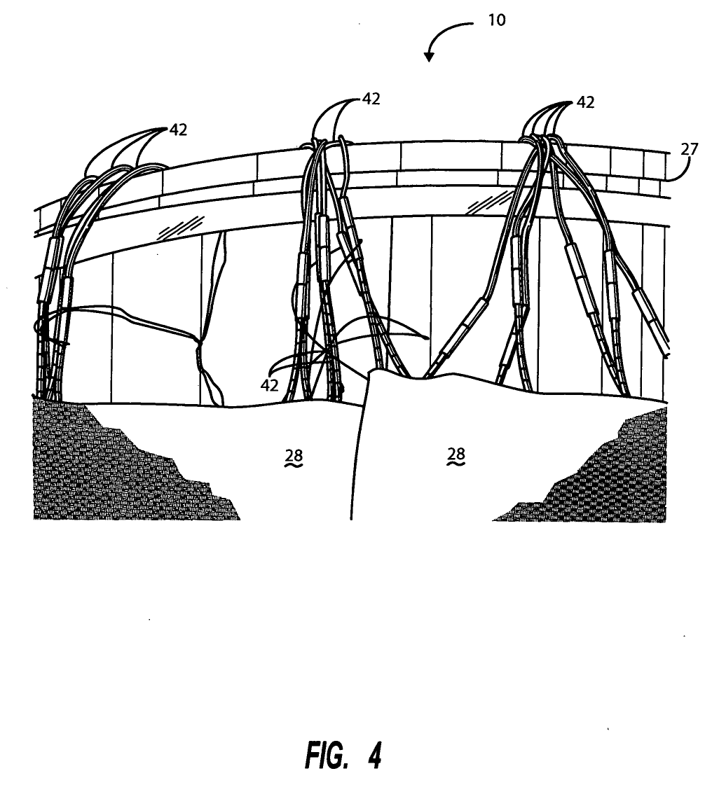

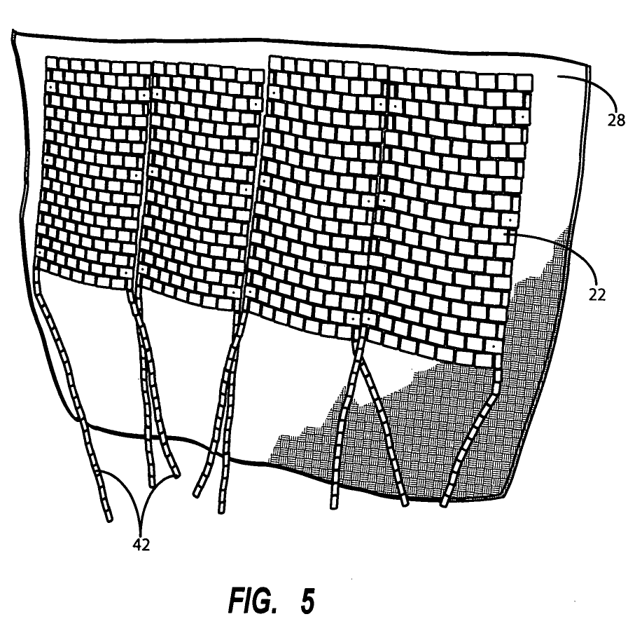

FIG. 1 depicts a perspective view, with parts removed for clarity, of a steam generator enclosure vessel for a nuclear power plant shown generally at 10 which has a pair of vessel shell sections, including an upper section 12 and a lower section 14. Connecting conduits are shown at 16 and 18 in the upper section. The sections are assembled together and a peripheral or girth weld seam is shown at 20. Arrays of electric heating pad elements as at 22 are provided on both sides extending along and flanking the weld seam 20. The heating elements are held against the outer surface of the shell sections 12 and 14 as will be explained. As best seen in FIGS. 3 and 5, the heating pad elements 22 may be of an articulated ceramic bead construction. The upper pads 22 may be held in place about the vessel shell section 12 by a pair of straps 24 and 26 (FIG. 3) and by suspension wires strung from upper band 27 (FIG. 1a) which prevent the upper pads, etc., from sliding down the vessel. Sections of insulating material 28 are connected over the pads 22.

The lower heating pad elements may be fastened to insulation sections 28 prior to application to the outer shell of the lower section 14. The lower array of heating pad elements 22 and overlying insulation pads 28 are preferably held in place by a metal band 30 which consists of a plurality of consecutively joined segments as at 32 (FIG. 1b) which combine to extend around the girth of the vessel shell section 14. As shown in FIG. 1c, the sections 32 are provided with gusset members 34 to which post support members 36 can be fastened. The post members 36 combine with associated band members 38 to further hold the insulation sections 28 in place. The support band segments 32 are held together about the periphery of shell section 14 by a number of clamps 40. As shown in FIGS. 3 and 5, a plurality of electrical connectors as at 42 are provided for supplying current to each of the heating pad elements 22.

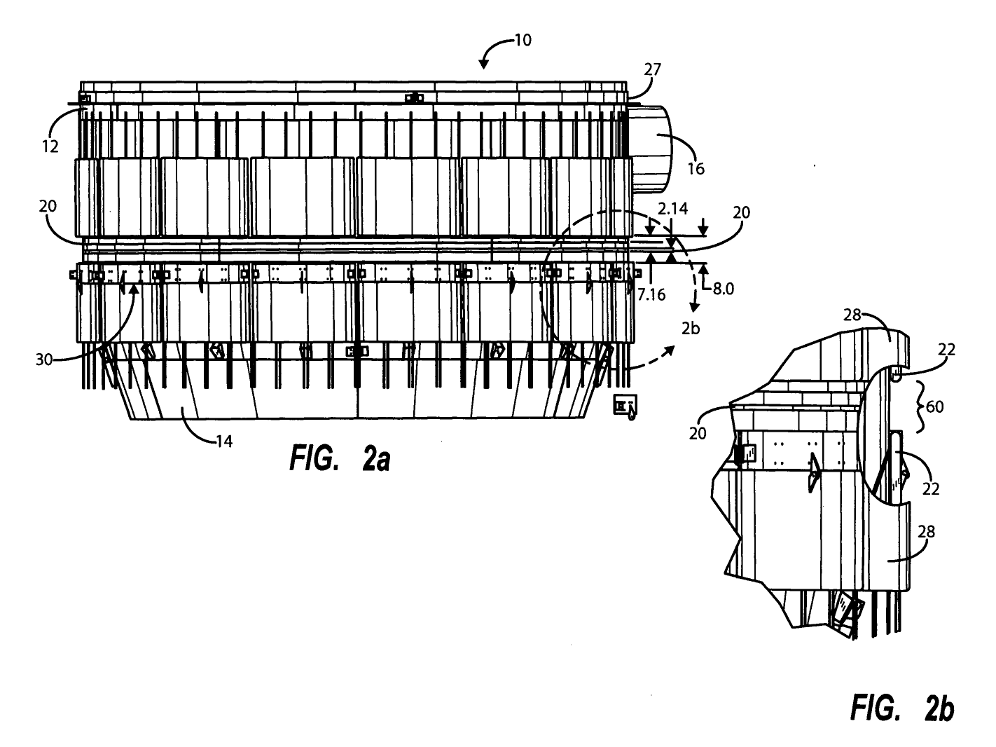

A further framework is provided to support insultation inside the vessel as shown in FIG. 1a. That system features a lower or bottom central inner ring 43 which supports the lower end of a series of adjustable upper and lower braces 44 and 46, respectively, which, in turn, hold respective upper and lower retainer brace plate members 48 and 50 against inner insulation sections 52. The insulation sections 52 extend about the periphery of the inner wall surface of both shell sections 12 and 14, each being retained by a set including upper and lower braces. This minimizes pre-heat loss through the inner surfaces of the vessel sections 12 and 14 to be joined at the seam 20. As best shown in FIG. 2a and the enlarged fragment of FIG. 2b, an open gap 60 is provided along the weld seam 20 that extends on either side of the seam for ease of welding.

It will be appreciated from the foregoing that heat from the peripherally placed upper and lower sections of ceramic heating pad elements 22 will keep the vicinity of the girth weld seam 20 at a uniform elevated temperature about the girth of the vessel. It is also evident that this is accomplished without the need to weld or otherwise attach any retaining pins or other members directly to the metal surface of either the inner or outer surfaces of either the upper or lower vessel shell segments. This enables re-welding to proceed in many older vessels in which traditional methods are no longer viable.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A heating system for pre-heating assembled large metal vessel shell sections along and on either side of a weld seam joining said shell sections comprising:
(a) a pair of vessel shell sections having inner and outer surfaces assembled forming a weld seam therebetween to be joined by a peripheral weld;
(b) a plurality of heating elements arranged about the outer periphery of said shell sections on either side of said weld seam;
(c) a layer of external insulating material overlaying said heating elements;
(d) peripheral strap devices holding said heating elements and said insulating material against the outer surface of said vessel shell sections;
(e) a layer of internal insulating material disposed about a portion of said inner surface including the area of said weld seam; and
(f) a retention bracing system for holding said layer of internal insulation against the inner surface of said vessel shell sections.

2. A heating system as in claim 1 wherein said pair of shell sections are the upper and lower halves of a large vessel.

3. A heating system as in claim 1 wherein said heating elements are electric ceramic heating pad elements.

4. A heating system as in claim 1 wherein said external insulating material is in the form of a plurality of sections.

5. A heating system as in claim 3 wherein said external insulating material is in the form of a plurality of sections.

6. A heating system as in claim 5 wherein said insulation sections are fastened to said heating pad elements.

7. A heating system as in claim 1 wherein at least one of said peripheral strap devices includes a plurality of sections clamped together.

8. A heating system as in claim 2 wherein at least one of said peripheral strap devices includes a plurality of sections clamped together.

9. A heating system as in claim 2 further comprising suspension wires for retaining said heating element in said upper half of said vessel.

10. A heating system as in claim 8 further comprising suspension wires for retaining said heating element in said upper half of said vessel.

11. A heating system as in claim 1 wherein said retention bracing system for holding said layer of internal insulation against the inner surface of said shell sections includes a central ring supporting upper and lower outwardly-directed bracing members which address the upper and lower portions of individual insulating pads.

12. A heating system as in claim 11 wherein said bracing members are adjustable.

13. A method of pre-heating a pair of vessel shell sections to be joined by a girth weld, each of said sections having an inner and an outer surface, to form an assembled vessel comprising:
(a) applying a plurality of heating devices about the circumference of the outer surface of each of said pair of vessel sections in the vicinity of and flanking, but apart from, said girth weld;
(b) applying a layer of external insulating material about the circumference of the outer surface of each of said pair of vessel sections covering said heating devices;
(c) applying a layer of internal insulating material about the circumference of the inner surface covering the girth in the vicinity of the weld location;
(d) applying external retention system about the circumference of the outer surface of said pair of vessel sections for holding said external insulation material and said heating devices in place;
(e) providing an internal retention system including a framework for retaining said internal insulating material against said inner surface; and
(f) wherein said internal and external retention systems do not attach to surfaces of said vessel sections.
